(19) United States
(12) Patent Application Publication
(10) Pub. No.: US 2025/0278895 A1
(43) Pub. Date: Sep. 4, 2025

(54) THREE DIMENSIONAL ORGAN RECONSTRUCTION FROM TWO DIMENSIONAL SPARSE IMAGING DATA

(71) Applicant: Siemens Medical Solutions USA, Inc., Malvern, PA (US)

(72) Inventors: Athira Jane Jacob, Plainsboro, NJ (US); Paul Klein, Princeton, NJ (US); Gareth Funka-Lea, Princeton, NJ (US)

(21) Appl. No.: 18/748,625

(22) Filed: Jun. 20, 2024

Related U.S. Application Data
(60) Provisional application No. 63/559,332, filed on Feb. 29, 2024.

(51) Int. Cl. G06T 17/20; G06T 7/00

(52) U.S. Cl. CPC G06T 17/20; G06T 7/00; G06T 2207/10088; G06T 2207/20081; G06T 2207/30048

(57) ABSTRACT

Systems and methods for three dimensional reconstruction from two dimensional imaging data. An neural implicit shape function model is used to regress a shape of an organ from two dimensional sparse imaging data. Contours of the organ are generated from the two dimensional sparse imaging data. The contours are used to train the neural implicit shape function model to regress the shape of the organ.

### CROSS REFERENCE TO RELATED APPLICATIONS

This patent document claims the benefit of the filing date under 35 U.S.C. § 119(e) of U.S. Provisional Patent Application Ser. No. 63/559,332 filed on Feb. 29, 2024, which is hereby incorporated in its entirety by reference.

### FIELD

This disclosure relates to medical imaging.

### BACKGROUND

Three dimensional (3D) reconstruction is used to create a three dimensional model of an object or scene from a series of two dimensional (2D) images. Three dimensional reconstruction may help in planning and monitoring pre-operative and post-operative medical conditions of patients. Different modalities may be used, for example, two dimensional medical image formats such as magnetic resonance imaging (MRI), CT, positron emission tomography (PET), x-rays, ultrasound, and microscopy have been used for three dimensional reconstruction.

Three dimensional shape reconstruction from two dimensional sparse images is a challenging problem. In an example, cardiac ablation procedures using two dimensional intracardiac echocardiography involve taking multiple two dimensional images of the heart. A clinical application specialist (CAS) then annotates organs of interest on these two dimensional images which are then used to reconstruct the organs in three dimensional to guide the procedure. This process is time consuming and requires high anatomical expertise and echocardiography expertise to recognize structures in the sparse two dimensional data.

### SUMMARY

By way of introduction, the preferred embodiments described below include methods, systems, instructions, and computer readable media for three dimensional organ reconstruction from two dimensional sparse imaging data.

In a first aspect, a method for three dimensional organ reconstruction from two dimensional sparse imaging data, the method comprising: acquiring a plurality of two dimensional medical images of a patient; generating organ contours in the plurality of two dimensional medical images; training a neural implicit shape function model with the organ contours to regress a three dimensional organ shape; and generating the three dimensional organ shape using the trained neural implicit shape function model.

In a second aspect, a system for three dimensional reconstruction from two dimensional imaging data, the system comprising: a medical imaging device configured to acquire a plurality of two dimensional images of a feature of a patient; a memory configured to store a boundary detection machine learned model and an neural implicit shape function model; a processor configured to generate feature contours in each of the plurality of two dimensional images using the boundary detection machine learned model and generate a three dimensional feature shape from the feature contours using the neural implicit shape function model; and a display configured to display the three dimensional feature shape.

In a third aspect, a non-transitory computer implemented storage medium that stores machine-readable instructions executable by at least one processor, the machine-readable instructions comprising: acquiring sparse three dimensional data of a volume; training an neural implicit shape function model using the sparse three dimensional data to predict a signed distance of a respective location in the volume to a closest boundary of an feature; and generating a three dimensional feature shape by iterating over a plurality of locations in the volume.

Any one or more of the aspects described above may be used alone or in combination. These and other aspects, features and advantages will become apparent from the following detailed description of preferred embodiments, which is to be read in connection with the accompanying drawings. The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the embodiments. Moreover, in the figures, like reference numerals designate corresponding parts throughout the different views.

FIG. 1 depicts an example system for reconstructing three dimensional anatomies from sparse two dimensional images according to an embodiment.

FIG. 2 depicts an example workflow for determining contours of a feature in two dimensional images according to an embodiment.

FIG. 3 depicts an example workflow for regressing a three dimensional shape from two dimensional organ contours according to an embodiment.

FIG. 4 depicts a method for reconstructing three dimensional anatomies from sparse two dimensional images according to an embodiment.

FIG. 5 depicts an artificial neural network that may be used to implement one or more embodiments.

FIG. 6 depicts a convolutional neural network that may be used to implement one or more embodiments.

FIG. 7 depicts an example auto decoder network that may be used to implement one or more embodiments.

### DETAILED DESCRIPTION

Embodiments described herein provide systems and methods for using a deep learning method to reconstruct three dimensional anatomies from sparse two dimensional images. A first stage involves boundary detection and contour generation for each of a plurality of acquired two dimensional images using, for example, a deep learning (DL) network. A second stage provides shape regression conditioned on the contours using neural implicit functions. Embodiments may be used in existing clinical workflow for editing. Embodiments may be used to reconstruct three dimensional organs from different imaging modalities such as two dimensional magnetic resonance images.

Traditionally two dimensional images have been used to reconstruct three dimensional anatomies using various methods. The most commonly used method include meshes, voxel-based, or point-based techniques. There approaches have inherent tradeoffs regarding efficiency (voxel-based representations memory usage grows cubically with respect to the resolution), expressivity (fine geometry is hard to model using meshes), or topological constraints (producing a watertight surface, i.e. a closed surface with no holes in it, directly from a point cloud may not be a trivial task). In addition, each of these techniques rely on an explicit formulation of the geometry. However, it does so by approximating the three dimensional surface with discrete objects, such as triangles, grids, or simply points.

Image segmentation and segmentation mask prediction are two common problems in three dimensional reconstruction. Different methods may be used for segmentation and mask prediction. Thresholding-based methods use a threshold to filter the background. The output is a binary image with pixels that are either inside or outside the object of interest. These methods are suitable for intensity-based region discovery. Region growing methods start with a seed pixel as a node and join neighboring pixels with similar intensity. Region-merging and splitting intake an entire image and segment it into sub-images in iterative steps based on a similarity measure between inter-segment metrics until no further segmentation is possible. Clustering-based methods use a distance measure for the intensity values to segment into multiple clusters. A limitation in clustering is that smooth edges and gradual intensity transitions are not easily grouped into non-intersecting clusters. Edge-detection methods use layers of Gaussian filters, changing their sigma values for edge detection. These methods segment the image without understanding the underlying shape information or region semantics. In addition, point clouds lack the connectivity structure of the underlying mesh and hence require additional postprocessing steps to extract three dimensional geometry from a model. Existing mesh representations are typically based on deforming a template mesh and hence do not allow arbitrary topologies. Moreover, these approaches are limited in the number of points/vertices which may be reliably predicted using a standard feed-forward network.

Another way to represent three dimensional objects is using continuous implicit representations. Implicit neural representations, also referred to as coordinate-based representations, are a technique that parameterize signals. Conventional signal representations are discrete, for example images are discrete grids of pixels and three dimensional shapes may be parameterized as grids of voxels, point clouds, or meshes. In contrast, implicit neural representations parameterize a signal as a continuous function that maps the domain of the signal to whatever is at that coordinate. In embodiments described below, the neural implicit representations may be provided by neural networks that estimate the function F that represents a signal continuously, by training on discretely represented samples of the same signal. In an embodiment, an implicit function represents a geometry as a function that operates on a three dimensional point that satisfies the following conditions: F(x,y,z)<0—interior point, F(x,y,z)>0—exterior point, and F(x,y,z)=0—surface point. A function referred to as the Signed Distance Function (SDF) satisfies these properties. The SDF is the distance of a given point to the object boundary and sets the sign of the distance accordingly to the rules above. The signed distance function is a continuous function that, for a given spatial point, outputs the point's distance to the closest surface, whose sign encodes whether the point is inside (negative) or outside (positive) of the surface.

Embodiments described herein use implicit representations to generate a three dimensional shape of an organ from two dimensional images. Embodiments include two stages of image processing: a boundary detection stage and a shape reconstruction stage. For the boundary detection stage, a method detects full or partial organ boundaries in acquired two dimensional images of a patient including a feature of interest, for example an organ. A deep learning method may be used that has been trained with an existing database of images with annotated contours as ground truth. One embodiment involves converting the annotated contours into contour heat maps. A deep learning based image to image network, for example a U-Net, is then trained to predict the heat maps.

For the shape reconstruction stage the two dimensional contours from the first stage are projected into a three dimensional space using image header information. The image header information provides for registration to a common coordinate system. Other registration methods may be used. A neural implicit shape function model is trained by taking as input the registered contours from the two dimensional images and regressing an organ shape in the form of a voxelated mask. The model iterates over every point in the region of interest and predicts the signed distance of the point to the closest boundary or classifies the point as lying inside or outside the shape. The input contours may be in the form of three dimensional coordinates in space, or for example voxelized as three dimensional volumes, where every voxel value represents the distance of that voxel to the closest contour. Another embodiment involves using feature maps from the image to image network in the first stage that produced the heat maps, and concatenating the feature maps along with the point coordinates as an input to the shape function.

Embodiments provide three dimensional reconstruction of organs of interest without requiring a full set of contours covering the full structures (e.g., sparse data). Embodiments may be used to iteratively reconstruct an organ by fanning a catheter across the organ and adding contours one by one. While the embodiments described below focus on ICE images, the method may be used for reconstruction with other two dimensional medical images such as MRI two dimensional images.

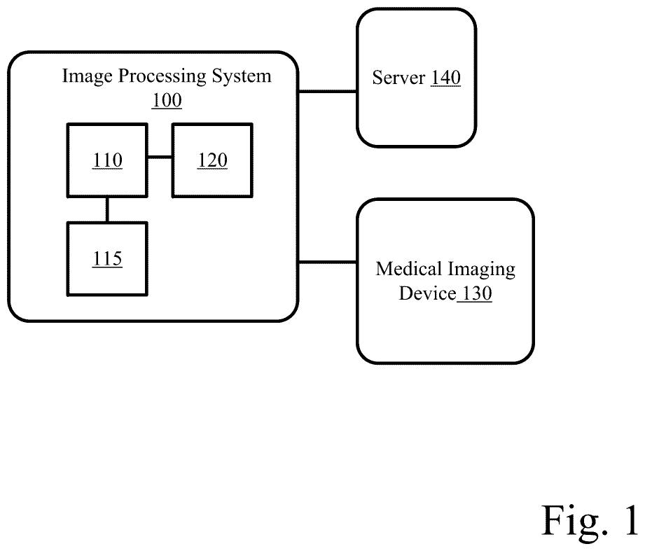

FIG. 1 depicts an example system 100 for three dimensional organ reconstruction from two dimensional sparse imaging data. The system includes an image processing system 100, a medical imaging device 130, and optionally a server 140. The server 140 may be configured to perform any of the tasks of the image processing system 100 including processing and/or storing of the data and models. The server 140 may be or include a cloud-based platform. The image processing system 100 includes a processor 110, a memory 120, and a display 115. The image processing system 100 may be included with or coupled to the medical imaging device 130. The image processing system 100 is configured to receive the image data from the medical imaging device 130, generate organ contours, and reconstruction a representation of a three dimensional organ therefrom. The image processing system 100 may also be configured to train or store a machine learned model for these tasks. Imaging data is acquired from the medical imaging device 130 for example as an ultrasound sequence. A machine learned model may be used to generate the contours using a boundary detection method and/or segmentation. The contours from the two dimensional images are input into an neural implicit model which regresses the organ shape in three-dimensions. Additional, different, or fewer components may be provided. For example, a computer network is included for remote processing of locally captured ultrasound data, for example by the server 140. As another example, a user input device (e.g., keyboard, buttons, sliders, dials, trackball, mouse, or other device) is provided for user input or annotations.

For the medical imaging device 130, one example used herein is in an ultrasound context, but other types of scanners may be used (e.g., MR, PET, SPECT, or other medical imaging devices). In an embodiment, the medical imaging device 130 is an ultrasound system 130 configured to generate two dimensional ultrasound images of a patient. Ultrasound imaging uses sound waves to image internal body structures. Techniques include transthoracic echocardiogram (TTE), transesophageal echocardiogram (TEE), and Intracardiac Ultrasound (ICE) among others. TTE is a non-invasive procedure where a transducer (or probe) is placed on the chest of the patient. Images are recorded using ultrasound data. For TEE, the probe is passed through a patient's esophagus in order to be near the patient's heart. The probe may have an ultrasound transducer at the tip in order to provide imaging capabilities. ICE uses a catheter transducer element. The catheter is threaded thru a vein in the groin and up into the heart. ICE may be used to perform an echocardiogram that uses sound waves to produce detailed images of the heart's size, structure, and function, as well as detailed images of the heart's valves. In addition to imaging, the echocardiogram may also be used to measure the heart's blood volume, and the speed and direction of blood flow through the heart. In an embodiment, the medical imaging device 130 is configured to acquire sparse two dimensional images of a region of interest of a patient, for example, of an organ of the patient using an image modality such as ultrasound or MRI. The term sparse refers to the amount of data, for example, where data is not acquired for each potential voxel of a three dimensional representation of the organ/feature of interest.

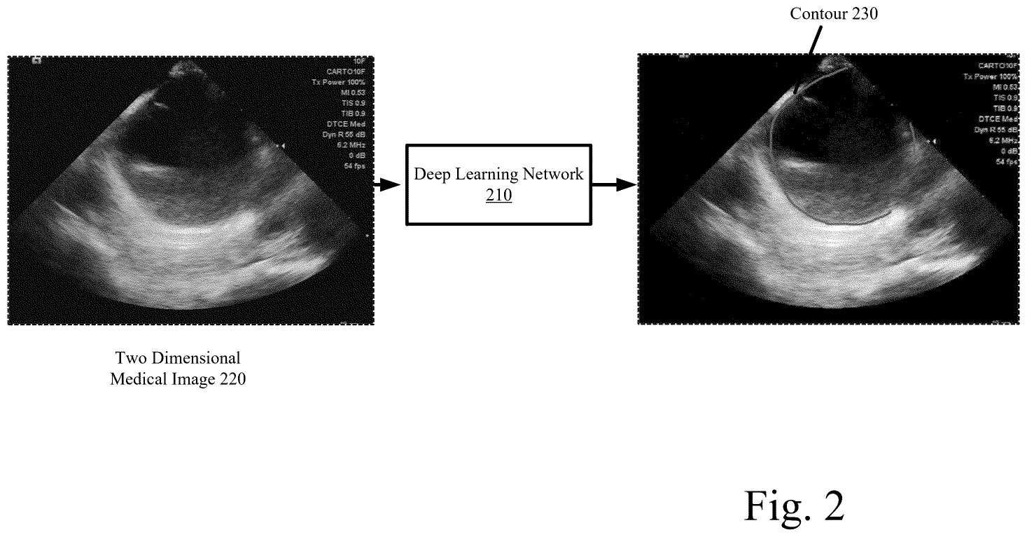

The processor 110 is a general processor, digital signal processor, graphics processing unit, application specific integrated circuit, field programmable gate array, artificial intelligence processor, digital circuit, analog circuit, combinations thereof, or other now known or later developed device for two dimensional to three dimensional reconstruction, among other processes described below. The processor 110 is a single device, a plurality of devices, or a network. For more than one device, parallel or sequential division of processing may be used. Different devices making up the processor 110 may perform different functions. In one embodiment, the processor 110 is a control processor or other processor of the medical imaging device 130. In other embodiments, the processor 110 is part of a separate workstation or computer, for example, the server 140 or part of a cloud based system. The processor 110 operates pursuant to stored instructions to perform various acts described herein. The processor 110 is configured by software, design, firmware, and/or hardware to perform any or all of the acts of FIG. 2, 3, 4 and any other computations described herein.

In a first stage, the processor 110 is configured to determine a boundary of an organ or feature in each of the two dimensional images and generate two dimensional contours of the organ/feature. FIG. 2 depicts an example of the first stage including generating the contours 230. Two dimensional medical images 220 are input into a deep learning network 210 that is configured to output contours 230.

In an embodiment, the processor 110 is configured to segment the two dimensional images 220, for example using a machine trained model 210. The image segmentation may extract or identify regions of interest (ROI) through a semiautomatic or automatic process. Segmentation divides an image into areas based on a specified description, such as segmenting body organs/tissue. The segmented data may be used for different applications such as analyzing the respective organ or feature. In an embodiment, the segmentation provides contours 230 of an organ/feature of interest in the two dimensional image. Any method for segmentation may be used. For example, segmentation may be thresholding-based, region-based, shape-based, model based, neighboring based, and/or machine learning-based among other segmentation techniques. Thresholding-based methods segment the image data by creating binary partitions based on image attenuation values, as determined by the relative attenuation of structures on the images. Region-based segmentation compares one pixel in an image to neighboring pixels, and if a predefined region criterion (e.g., homogeneity) is met, then the pixel is assigned to the same class as one or more of its neighbors. Shape-based techniques use either an atlas-based approach or a model-based approach to find a lumen boundary. Model-based methods use prior shape information, similar to atlas-based approaches; however, to better accommodate the shape variabilities, the model-based approaches fit either statistical shape or appearance models of the organ to the image by using an optimization procedure. The segmentation may be provided by a segmentation model and the output of the medical imaging device 130. Different types of models or networks may be trained and used for the segmentation task. The processor 110 is configured to generate contours 230 of an organ from the two dimensional images, for example, using the segmented image data or though other methods.

In an embodiment, the processor 110 detects full or partial organ boundaries in the two dimensional images 220 acquired during an ultrasound procedure, for example an ICE procedure. A deep learning method may be used that has been trained with an existing database of ICE images with clinical application specialist (CAS) annotated contours as ground truth. One embodiment involves converting the CAS drawn contours into contour heat maps. A deep learning based image to image network, for example a U-Net, is trained to predict the heat maps.

In an embodiment, the processor 110 is configured to train and/or implement one or more machine learned networks, for example for segmentation, boundary detection, and/or generating a neural implicit representation. The machine learned network(s) or model(s) may include a neural network that is defined as a plurality of sequential feature units or layers. Sequential is used to indicate the general flow of output feature values from one layer to input to a next layer. Sequential is used to indicate the general flow of output feature values from one layer to input to a next layer. The information from the next layer is fed to the next layer, and so on until the final output. The layers may only feed forward or may be bi-directional, including some feedback to a previous layer. The nodes of each layer or unit may connect with all or only a sub-set of nodes of a previous and/or subsequent layer or unit. Skip connections may be used, such as a layer outputting to the sequentially next layer as well as other layers. Rather than pre-programming the features and trying to relate the features to attributes, the deep architecture is defined to learn the features at different levels of abstraction based on the input data. The features are learned to reconstruct lower-level features (i.e., features at a more abstract or compressed level). Each node of the unit represents a feature. Different units are provided for learning different features. Various units or layers may be used, such as convolutional, pooling (e.g., max pooling), deconvolutional, fully connected, or other types of layers. Within a unit or layer, any number of nodes is provided. For example, 100 nodes are provided. Later or subsequent units may have more, fewer, or the same number of nodes. Different configurations of networks may be used for different applications. Different training mechanisms and training data may be used for different applications.

The image data, the machine trained models/networks, training data, contour data, three dimensional representation data, and other data may be stored in the memory 120. The memory 120 may be or include an external storage device, RAM, ROM, database, and/or a local memory (e.g., solid state drive or hard drive). The same or different non-transitory computer readable media may be used for the instructions and other data. The memory 120 may be implemented using a database management system (DBMS) and residing on a memory 120, such as a hard disk, RAM, or removable media. Alternatively, the memory 120 is internal to the processor 110 (e.g., cache). The instructions for implementing the processes, methods, and/or techniques discussed herein are provided on non-transitory computer-readable storage media or memories, such as a cache, buffer, RAM, removable media, hard drive, or other computer readable storage media (e.g., the memory 120). The instructions are executable by the processor 110 or another processor. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the instructions set, storage media, processor 110 or processing strategy and may be performed by software, hardware, integrated circuits, firmware, micro code, and the like, operating alone or in combination. In one embodiment, the instructions are stored on a removable media device for reading by local or remote systems. In other embodiments, the instructions are stored in a remote location for transfer through a computer network. In yet other embodiments, the instructions are stored within a given computer, CPU, GPU, or system. Because some of the constituent system components and method steps depicted in the accompanying figures may be implemented in software, the actual connections between the system components (or the process steps) may differ depending upon the manner in which the present embodiments are programmed.

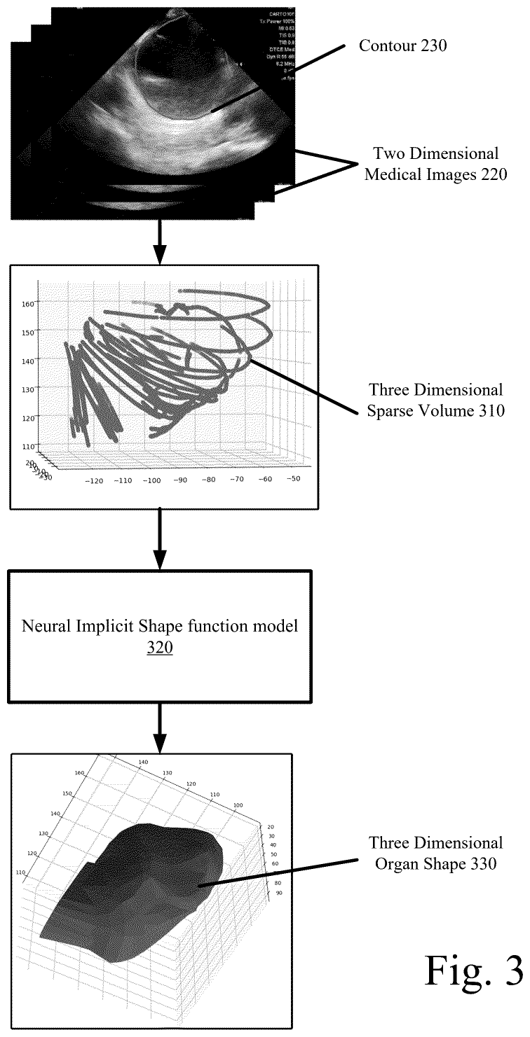

In a second stage, the processor 110 is configured to regress a three dimensional feature shape from the contours 230 using a neural implicit shape function model. FIG. 3 depicts an example of the second stage of the method. In FIG. 3, the contours 230 of the two dimensional medical images 220 are aggregated to generate a three dimensional sparse volume 310. The contours 230 of the three dimensional sparse volume 310 are used to train/configure the neural implicit shape function model 320. The neural implicit shape function model 320 is configured to regress the three dimensional organ shape 330.

As depicted in FIG. 3, the two dimensional contours 230 are projected into a three dimensional space using image header information. The image header information provides for values that allow the two dimensional images 220 to be registered to a common 3D coordinate system. The two dimensional images 220 (and contours 230) may be parallel to one another or askew. In certain medical imaging procedures, multiple slices are acquired of the organ by moving the patient or device along one axis. In an ICE ultrasound procedure, the slices/two dimensional images 220 may be acquired at different angles and thus may not be parallel to one another. Once registered to a common coordinate system in 3D, the contours 230 are input into a machine trained neural implicit shape function model 320.

The neural implicit shape function model 320 is machine trained by inputting the contours 230 and regressing an organ shape in the form of a voxelized mask. In an embodiment, every point of the region of interest is used and a signed distance (SDF) of the point to the closest boundary is predicted. Alternatively, the point is classified as lying inside or outside the shape. The input contours 230 may be in the form of three dimensional coordinates in space, or voxelized as three dimensional volumes, where every voxel value represents the distance of that voxel to the closest contour. Another embodiment involves using feature maps that produced the heat maps, and concatenating them along with the point coordinates as an input to ethe shape function. In an embodiment, the neural implicit shape function model 320 is represented as y=f(x,p) where y is a binary value indicating whether the point is inside the object or outside, or a signed distance to the nearest boundary of the object to be segmented (The signed distance values may then later be converted to a binary mask), x is a three dimensional query coordinate for which the prediction is made, and p is patient specific information such as the three dimensional coordinates of the already delineated contours 230, or three dimensional patches of the contour heatmap centered around x, or image features around. The mask for the whole three dimensional volume is obtained by iterating over all x (and p, if applicable).

The processor 110 outputs the mask and/or a representation of the organ shape. The display 115 is configured to display or otherwise provide the mask and/or the representation of to the user. The display 115 is a CRT, LCD, projector, plasma, printer, tablet, smart phone or other now known or later developed display device for displaying the output.

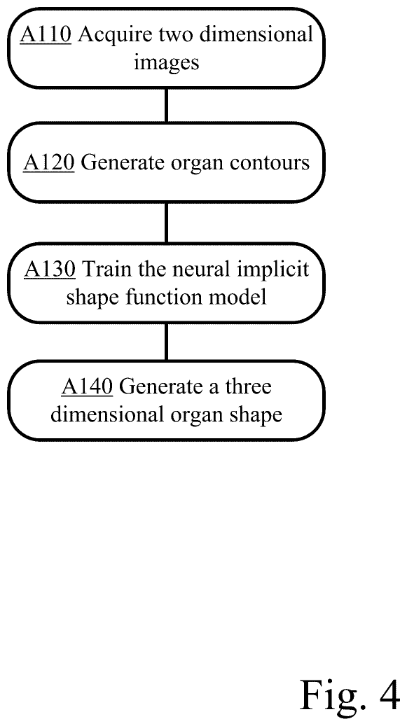

FIG. 4 depicts a method for three dimensional organ reconstruction from two dimensional sparse imaging data. The acts are performed by the system of FIGS. 1, 2, 3, other systems, a workstation, a computer, and/or a server. Additional, different, or fewer acts may be provided. The acts are performed in the order shown (e.g., top to bottom) or other orders. Certain acts may be omitted or changed depending on the results of the previous acts and the status of the patient.

At act A110, a plurality of two dimensional medical images 220 of a patient are acquired. In an embodiment, the method is performed by a medical diagnostic ultrasound scanner 130. Alternative imaging modalities may be used that acquire two dimensional images 220. For example, two dimensional MRI images may be acquired and used to reconstruct a three dimensional representation. In an embodiment, a transducer of an Intracardiac Echocardiography (ICE) catheter acquires ultrasound data of an organ of a patient. Each scan by the ICE catheter produces a two dimensional visualization of a slice of the organ, for example the patient's heart. The scan data may be represented by scalar values or display values (e.g., RGB) in a polar coordinate or Cartesian coordinate format. The ultrasound data may be a B-mode, color flow, or other ultrasound image. A plurality of two dimensional frames of data result from the imaging. In an example, ICE is used to acquire images of the cardiac structures. These images and resulting three dimensional representation may be used to guide cardiologists or provide information for further analysis of the heart of the patient.

At act A120, organ contours 230 are generated in the plurality of two dimensional medical images. In each slice the contour/boundary of an organ of interest is identified. Different methods may be used for boundary detection. In an embodiment, the two dimensional image is segmented and different organs/tissues are classified/identified. Different methods may be used for segmentation. For example, segmentation may be thresholding-based, region-based, shape-based, model based, neighboring based, and/or machine learning-based among other segmentation techniques. Thresholding-based methods segment the image data by creating binary partitions based on image attenuation values, as determined by the relative attenuation of structures on the images. Region-based segmentation compares one pixel in an image to neighboring pixels, and if a predefined region criterion (e.g., homogeneity) is met, then the pixel is assigned to the same class as one or more of its neighbors. Shape-based techniques use either an atlas-based approach or a model-based approach to find a boundary of the organ. Model-based methods use prior shape information, similar to atlas-based approaches; however, to better accommodate the shape variabilities, the model-based approaches may fit either statistical shape or appearance models of the organ to the image by using an optimization procedure. Neighboring anatomy-guided methods use the spatial context of neighboring anatomic objects. In machine learning-based methods, boundaries are predicted on the basis of the features extracted from the image data.

Machine learning for image segmentation may be done by extracting a selection of features from input images. These features may include, for example, pixel gray levels, pixel locations, image moments, information about a pixel's neighborhood, etc. A vector of image features is then fed into a learned classifier which classifies each pixel of the image into a class. The parameters of the classifier are learned automatically by giving the classifier input images for which the ground truth classification results is known, for example CAS annotated images. The output of the model is then compared to the ground truth, and the parameters of the model are adjusted so that the model's output better matches the ground truth value. This procedure is repeated for a large amount of input images, so that the learned parameters generalize to new, unseen examples. Deep learning may also be used for segmentation (and other tasks described herein), for example using a neural network. Deep learning-based image segmentation may be done, for example, using a convolutional neural network (CNN). The convolutional neural network includes a layered structure where series of convolutions are performed on an input image. Kernels of the convolutions are learned during training. The convolution results are then combined using a learned statistical model that outputs a segmented image.

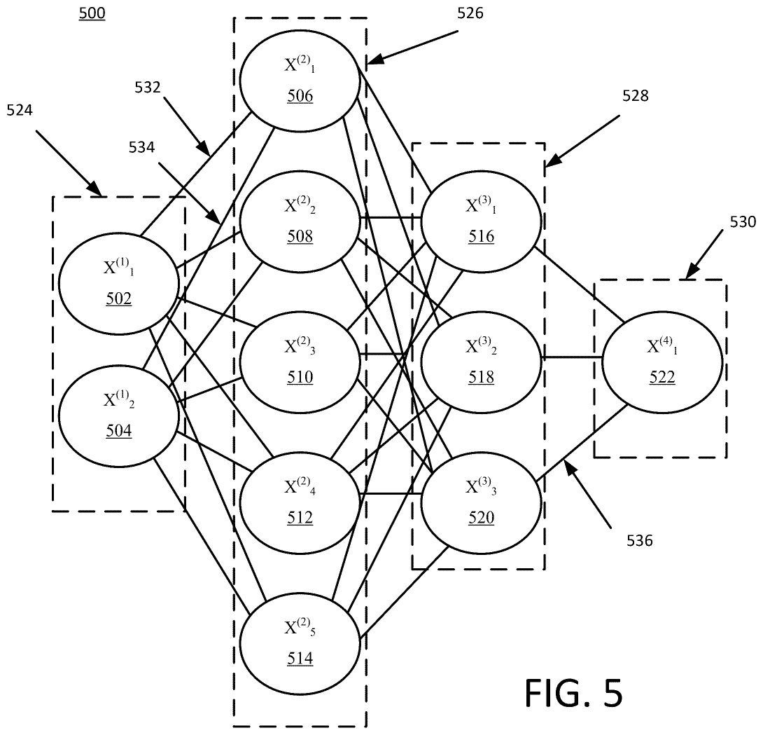

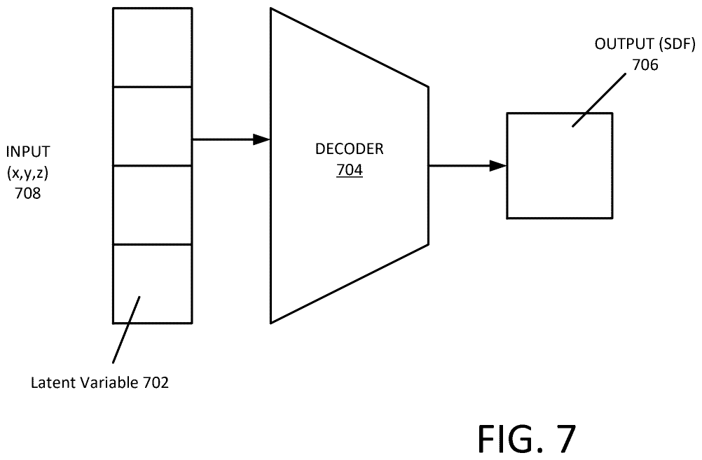

FIG. 5 shows an embodiment of an artificial neural network 500, in accordance with one or more embodiments. Alternative terms for “artificial neural network” are “neural network”, “artificial neural net” or “neural net”. The artificial neural network 500 may be used in part in, for example, the one or more machine learning based networks utilized for the neural implicit shape function model 320 of FIG. 3, for example, the decoder 704 as described below in FIG. 7.

The artificial neural network 500 includes nodes 502-522 and edges 532, 534, . . . , 536, wherein each edge 532, 534, . . . , 536 is a directed connection from a first node 502-522 to a second node 502-522. In general, the first node 502-522 and the second node 502-522 are different nodes 502-522, it is also possible that the first node 502-522 and the second node 502-522 are identical. For example, in FIG. 5, the edge 532 is a directed connection from the node 502 to the node 506, and the edge 534 is a directed connection from the node 504 to the node 506. An edge 532, 534, . . . , 536 from a first node 502-522 to a second node 502-522 is also denoted as “ingoing edge” for the second node 502-522 and as “outgoing edge” for the first node 502-522.

In this embodiment, the nodes 502-522 of the artificial neural network 500 may be arranged in layers 524-530, wherein the layers may include an intrinsic order introduced by the edges 532, 534, . . . , 536 between the nodes 502-522. In particular, edges 532, 534, . . . , 536 may exist only between neighboring layers of nodes. In the embodiment shown in FIG. 5, there is an input layer 524 including only nodes 502 and 504 without an incoming edge, an output layer 530 including only node 522 without outgoing edges, and hidden layers 526, 528 in-between the input layer 524 and the output layer 530. In general, the number of hidden layers 526, 528 may be chosen arbitrarily. The number of nodes 502 and 504 within the input layer 524 usually relates to the number of input values of the neural network 500, and the number of nodes 522 within the output layer 530 usually relates to the number of output values of the neural network 500.

In particular, a (real) number may be assigned as a value to every node 502-522 of the neural network 500. Here, x⁽ⁿ⁾; denotes the value of the i-th node 502-522 of the n-th layer 524-530. The values of the nodes 502-522 of the input layer 524 are equivalent to the input values of the neural network 500, the value of the node 522 of the output layer 530 is equivalent to the output value of the neural network 500. Furthermore, each edge 532, 534, . . . , 536 may include a weight being a real number, in particular, the weight is a real number within the interval [−1, 1] or within the interval [0, 1]. Here, w^{(m,n)}_{i,j} denotes the weight of the edge between the i-th node 502-522 of the m-th layer 524-530 and the j-th node 502-522 of the n-th layer 524-530. Furthermore, the abbreviation w⁽ⁿ⁾_{i,j} is defined for the weight w^{(n,n+1)}_{i,j}.

In particular, to calculate the output values of the neural network 500, the input values are propagated through the neural network. In particular, the values of the nodes 502-522 of the (n+1)-th layer 524-530 may be calculated based on the values of the nodes 502-522 of the n-th layer 524-530 by

$${x}_{j}^{( n + 1 )} = f ( {\sum }_{i} {x}_{i}^{( n )} \cdot {w}_{i , j}^{( n )} ) .$$

Herein, the function f is a transfer function (another term is “activation function”). Known transfer functions are step functions, sigmoid function (e.g. the logistic function, the generalized logistic function, the hyperbolic tangent, the Arctangent function, the error function, the smoothstep function) or rectifier functions. The transfer function is mainly used for normalization purposes.

In particular, the values are propagated layer-wise through the neural network, wherein values of the input layer 524 are given by the input of the neural network 500, wherein values of the first hidden layer 526 may be calculated based on the values of the input layer 524 of the neural network, wherein values of the second hidden layer 528 may be calculated based in the values of the first hidden layer 526, etc.

In order to set the values w^{(m,n)}_{i,j} for the edges, the neural network 500 has to be trained using training data. In particular, training data includes training input data and training output data (denoted as tᵢ). For a training step, the neural network 500 is applied to the training input data to generate calculated output data. In particular, the training data and the calculated output data include a number of values, said number being equal with the number of nodes of the output layer.

In particular, a comparison between the calculated output data and the training data is used to recursively adapt the weights within the neural network 500 (backpropagation algorithm). In particular, the weights are changed according to

$${w}_{i , j}^{( n )} = {w}_{i , j}^{( n )} - γ \cdot {δ}_{j}^{( n )} \cdot {x}_{i}^{( n )}$$

wherein γ is a learning rate, and the numbers δ⁽ⁿ⁾ⱼ may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δ⁽ⁿ⁺¹⁾ⱼ, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 530, wherein f′ is the first derivative of the activation function, and y⁽ⁿ⁺¹⁾ⱼ is the comparison training value for the j-th node of the output layer 530.

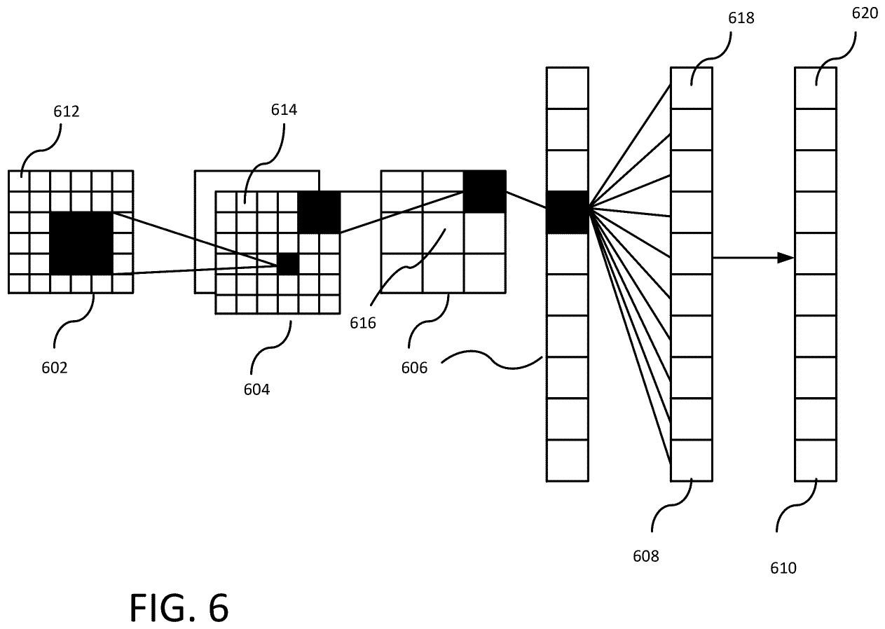

FIG. 6 shows a convolutional neural network 600, in accordance with one or more embodiments. Machine learning networks described herein, such as, e.g., the one or more machine learning based networks 210 for segmenting the two dimensional medical images 220 or generating the three dimensional organ shape 330 may be implemented using convolutional neural network 600.

In the embodiment shown in FIG. 6, the convolutional neural network includes 600 an input layer 602, a convolutional layer 604, a pooling layer 606, a fully connected layer 608, and an output layer 610. Alternatively, the convolutional neural network 600 may include several convolutional layers 604, several pooling layers 606, and several fully connected layers 608, as well as other types of layers. The order of the layers may be chosen arbitrarily, usually fully connected layers 608 are used as the last layers before the output layer 610.

In particular, within a convolutional neural network 600, the nodes 612-620 of one layer 602-610 may be considered to be arranged as a d-dimensional matrix or as a d-dimensional image. In particular, in the two-dimensional case the value of the node 612-620 indexed with i and j in the n-th layer 602-610 may be denoted as x⁽ⁿ_{)[i,j]}. However, the arrangement of the nodes 612-620 of one layer 602-610 does not have an effect on the calculations executed within the convolutional neural network 600 as such, since these are given solely by the structure and the weights of the edges.

In particular, a convolutional layer 604 is characterized by the structure and the weights of the incoming edges forming a convolution operation based on a certain number of kernels. In particular, the structure and the weights of the incoming edges are chosen such that the values x⁽ⁿ⁾ₖ of the nodes 614 of the convolutional layer 604 are calculated as a convolution x⁽ⁿ⁾ₖ=Kₖ*x⁽ⁿ⁻¹⁾ based on the values x⁽ⁿ⁻¹⁾ of the nodes 612 of the preceding layer 602, where the convolution * is defined in the two-dimensional case as

$${x}_{k}^{( n )} [ i , j ] = ( {K}_{k} * {x}^{( n - 1 )} ) [ i , j ] = {\sum }_{{i}^{′}} {\sum }_{{j}^{′}} {K}_{k} [ {i}^{′} , {j}^{′} ] \cdot {x}^{( n - 1 )} [ i - {i}^{′} , j - {j}^{′} ] .$$

Here the k-th kernel Kₖ is a d-dimensional matrix (in this embodiment a two-dimensional matrix), which is usually small compared to the number of nodes 612-618 (e.g. a 3×3 matrix, or a 5×5 matrix). In particular, this implies that the weights of the incoming edges are not independent, but chosen such that they produce said convolution equation. In particular, for a kernel being a 3×3 matrix, there are only 9 independent weights (each entry of the kernel matrix corresponding to one independent weight), irrespectively of the number of nodes 612-620 in the respective layer 602-610. In particular, for a convolutional layer 604, the number of nodes 614 in the convolutional layer is equivalent to the number of nodes 612 in the preceding layer 602 multiplied with the number of kernels.

If the nodes 612 of the preceding layer 602 are arranged as a d-dimensional matrix, using a plurality of kernels may be interpreted as adding a further dimension (denoted as “depth” dimension), so that the nodes 614 of the convolutional layer 604 are arranged as a (d+1)-dimensional matrix. If the nodes 612 of the preceding layer 602 are already arranged as a (d+1)-dimensional matrix including a depth dimension, using a plurality of kernels may be interpreted as expanding along the depth dimension, so that the nodes 614 of the convolutional layer 604 are arranged also as a (d+1)-dimensional matrix, wherein the size of the (d+1)-dimensional matrix with respect to the depth dimension is by a factor of the number of kernels larger than in the preceding layer 602.

The advantage of using convolutional layers 604 is that spatially local correlation of the input data may exploited by enforcing a local connectivity pattern between nodes of adjacent layers, in particular by each node being connected to only a small region of the nodes of the preceding layer.

In embodiment shown in FIG. 6, the input layer 602 includes 36 nodes 612, arranged as a two-dimensional 6×6 matrix. The convolutional layer 604 includes 72 nodes 614, arranged as two two-dimensional 6×6 matrices, each of the two matrices being the result of a convolution of the values of the input layer with a kernel. Equivalently, the nodes 614 of the convolutional layer 604 may be interpreted as arranges as a three-dimensional 6×6×2 matrix, wherein the last dimension is the depth dimension.

A pooling layer 606 may be characterized by the structure and the weights of the incoming edges and the activation function of its nodes 616 forming a pooling operation based on a non-linear pooling function f. For example, in the two dimensional case the values x⁽ⁿ⁾ of the nodes 616 of the pooling layer 606 may be calculated based on the values x⁽ⁿ⁻¹⁾ of the nodes 614 of the preceding layer 604 as

$${x}^{( n )} [ i , j ] = f ( {x}^{( n - 1 )} [ {id}_{1} , {jd}_{2} ] , … , {x}^{( n - 1 )} [ {id}_{1} + {d}_{1} - 1 , {jd}_{2} + {d}_{2} - 1 ] )$$

In other words, by using a pooling layer 606, the number of nodes 614, 616 may be reduced, by replacing a number d1·d2 of neighboring nodes 614 in the preceding layer 604 with a single node 616 being calculated as a function of the values of said number of neighboring nodes in the pooling layer. In particular, the pooling function f may be the max-function, the average or the L2-Norm. In particular, for a pooling layer 606 the weights of the incoming edges are fixed and are not modified by training.

The advantage of using a pooling layer 606 is that the number of nodes 614, 616 and the number of parameters is reduced. This leads to the amount of computation in the network being reduced and to a control of overfitting.

In the embodiment shown in FIG. 6, the pooling layer 606 is a max-pooling, replacing four neighboring nodes with only one node, the value being the maximum of the values of the four neighboring nodes. The max-pooling is applied to each d-dimensional matrix of the previous layer; in this embodiment, the max-pooling is applied to each of the two two-dimensional matrices, reducing the number of nodes from 72 to 18.

A fully-connected layer 608 may be characterized by the fact that a majority, in particular, all edges between nodes 616 of the previous layer 606 and the nodes 618 of the fully-connected layer 608 are present, and wherein the weight of each of the edges may be adjusted individually.

In this embodiment, the nodes 616 of the preceding layer 606 of the fully-connected layer 608 are displayed both as two-dimensional matrices, and additionally as non-related nodes (indicated as a line of nodes, wherein the number of nodes was reduced for a better presentability). In this embodiment, the number of nodes 618 in the fully connected layer 608 is equal to the number of nodes 616 in the preceding layer 606. Alternatively, the number of nodes 616, 618 may differ.

Furthermore, in this embodiment, the values of the nodes 620 of the output layer 610 are determined by applying the Softmax function onto the values of the nodes 618 of the preceding layer 608. By applying the Softmax function, the sum the values of all nodes 620 of the output layer 610 is 1, and all values of all nodes 620 of the output layer are real numbers between 0 and 1.

A convolutional neural network 600 may also include a ReLU (rectified linear units) layer or activation layers with non-linear transfer functions. In particular, the number of nodes and the structure of the nodes contained in a ReLU layer is equivalent to the number of nodes and the structure of the nodes contained in the preceding layer. In particular, the value of each node in the ReLU layer is calculated by applying a rectifying function to the value of the corresponding node of the preceding layer.

The input and output of different convolutional neural network blocks may be wired using summation (residual/dense neural networks), element-wise multiplication (attention) or other differentiable operators. Therefore, the convolutional neural network architecture may be nested rather than being sequential if the whole pipeline is differentiable.

In particular, convolutional neural networks 600 may be trained based on the backpropagation algorithm. For preventing overfitting, methods of regularization may be used, e.g. dropout of nodes 612-620, stochastic pooling, use of artificial data, weight decay based on the L1 or the L2 norm, or max norm constraints. Different loss functions may be combined for training the same neural network to reflect the joint training objectives. A subset of the neural network parameters may be excluded from optimization to retain the weights pretrained on another datasets.

The machine-learned network may be an image-to-image network, such as a fully convolutional U-net trained to convert an image to a segmented image. The trained convolution units, weights, links, and/or other characteristics of the network are applied to the data of the two dimensional images 220 and/or derived feature values to extract the corresponding features through a plurality of layers and output the segmentation. The features of the input are extracted from the images. Other more abstract features may be extracted from those extracted features using the architecture. Depending on the number and/or arrangement of units or layers, other features are extracted from the input. The network includes an encoder (convolutional) network and decoder (transposed-convolutional) network forming a “U” shape with a connection between passing features at a greatest level of compression or abstractness from the encoder to the decoder. Skip connections may be provided. Any now known or later developed U-Net architectures may be used. Other fully convolutional networks may be used. In one embodiment, the network is a U-Net with one or more skip connections. The skip connections pass features from the encoder to the decoder at other levels of abstraction or resolution than the most abstract (i.e. other than the bottleneck). Skip connections provide more information to the decoding layers. A fully convolutional layer may be at the bottleneck of the network (i.e., between the encoder and decoder at a most abstract level of layers). The fully connected layer may make sure as much information as possible is encoded. Batch normalization may be added to stabilize the training.

Other machine training architectures for segmentation may be used. Similarly for other tasks described herein, different machine training architectures may be used. For example, U-Net is used as described above. A convolutional-to-transposed-convolutional network may be used. One segment of layers or units applies convolution to increase abstractness or compression. The most abstract feature values are then output to another segment. The other segment of layers or units then applies transposed convolution to decrease abstractness or compression, resulting in outputting of an indication of class membership by location. The architecture may be a fully convolutional network. Other deep networks may be used. The machine learned network/model outputs boundaries of an organ for each two dimensional image. The boundary is referred to as a contour.

At act A130, a neural implicit shape function model 320 is trained to regress a three dimensional organ shape from the organ contours 230. The neural implicit shape function model 320 does not provide a discrete output but rather implements a continuous function that describes the shape of the organ/feature.

In an embodiment, the neural implicit shape function model 320 may be represented as y=f(x,p) where y is a binary value indicating whether the point is inside the object or outside, or a signed distance to the nearest boundary of the object to be segmented (The signed distance values may then later be converted to a binary mask), x is a 3D query coordinate for which the prediction is made, and p is patient specific information such as the 3D coordinates of the already delineated contours 230, or 3D patches of the contour heatmap centered around x, or image features around x. The mask for the whole 3D volume is obtained by iterating over all x (and p, if applicable).

In an embodiment, the neural implicit shape function model 320 outputs a signed distance function. A signed distance function (SDF) is a continuous function that, for a given spatial point, outputs the point's distance to the closest surface, whose sign encodes whether the point is inside (negative) or outside (positive) of the surface. For example, for each voxel, the x,y,z position is input to the SDF function which then outputs how far away the voxel is from a closest edge of the SDF shape. The SDF is directly regressed from point samples using a deep neural network. The resulting trained network is able to predict the SDF value of a given query position. A zero level-set surface may be extracted by evaluating spatial samples. The surface representation is intuitively understood as a spatial classifier for which the decision boundary is the surface of the shape itself.

In an embodiment, a set of pairs X are generated composed of the three dimensional point samples and their SDF values. The parameters of a multi-layer fully-connected neural network are trained using the training data to make the network a good approximator of the given SDF in the target domain. The training is done by minimizing the sum over losses between the predicted and real SDF values of points in X using an L1 loss function. Once trained, the surface is implicitly represented as the zero iso-surface of f(x), that may be visualized through different rendering techniques. In an embodiment, a latent vector z, that encodes a desired shape may be used as a second input to the neural network allowing for a more generalized model that may handle different shapes. By conditioning the network output on a latent vector, a single network may model multiple SDFs.

In an embodiment, the network directly regresses the continuous SDF from point samples using deep neural networks so that the resulting trained network is able to predict the SDF value of a given query point. The most direct application of this approach is to train a single deep network for a given target shape. However, training a specific neural network for each space may not be feasible. In an embodiment, the system is configured to model a variety of shapes with a single neural network. A latent vector is used as a second input to the neural network. The latent vector essentially encodes the desired shape. The neural network is the function of a latent code and a query point which outputs the shape's approximate SDF at that point.

In an example, an auto-decoder network is used. For reference, an auto-encoder uses an encoder-decoder architecture to learn representations of your input and then using those representations, reconstruct it back. A decoder-only network may be used where the latent vector assigned to each data point as well as the decoder weights are both optimized through backpropagation. For inference, an optimal latent vector is searched to match the new observation with fixed decoder parameters.

FIG. 7 depicts one example of an example auto decoder that may be used. The SDF prediction 706 is represented using a fully-connected network 704 with a loss function that penalizes the deviation of the network prediction from the actual SDF value. The input 708 to the decoder 704 is the coordinates and the latent vector 702. The output 706 is the SDF. The conditioning of the network with the vector 702 allows the network 704 to model a large space of shapes, where the shape information is contained in the vector 702 that is concatenated with the query point. In an example, the decoder 704 is a feed-forward network composed of eight fully connected layers, each of them applied with dropouts. All internal layers are 512-dimensional and have ReLU non-linearities. The output non-linearity regressing the SDF value is tanh.

In another embodiment, the function is implemented with a neural network that assigns to every location p∈R3 an occupancy probability between 0 and 1. This network is similar to a neural network for binary classification, except that here, the network is configured for predicting the decision boundary which implicitly represents the object's surface. In an embodiment, the function takes an observation x∈X as input and has a function from p∈R3 to R as output. This may be equivalently described by a function that takes a pair (p, x)∈R3×X as input and outputs a real number. The latter representation is parameterized by a neural network f that takes a pair (p, x) as input and outputs a real number which represents the probability of occupancy: f: R3×X→[0, 1]. In an embodiment, the network is a fully connected neural network. The network may be a convolutional neural network (CNN). The convolutional neural network includes a layered structure where series of convolutions are performed on an input image. Kernels of the convolutions are learned during training. Different network architectures may be used.

At act A140, a representation of the three dimensional organ shape 330 is generated. The resulting trained neural implicit shape function model 320 is able to predict the SDF value of a given query position, from which the zero level-set surface is extracted by evaluating spatial samples. The representation 330 may be rendered through ray casting or rasterization or another rendering technique.

While the invention has been described above by reference to various embodiments, many changes and modifications may be made without departing from the scope of the invention. It is therefore intended that the foregoing detailed description be regarded as illustrative rather than limiting, and that it be understood that it is the following claims, including all equivalents, that are intended to define the spirit and scope of this invention.

The following is a list of non-limiting illustrative embodiments disclosed herein:

Illustrative embodiment 1. A method for three dimensional organ reconstruction from two dimensional sparse imaging data, the method comprising: acquiring a plurality of two dimensional medical images of a patient; generating organ contours in the plurality of two dimensional medical images; training a neural implicit shape function model with the organ contours to regress a three dimensional organ shape; and generating the three dimensional organ shape using the trained neural implicit shape function model.

Illustrative embodiment 2. The method according to one of the preceding embodiments, wherein the neural implicit shape function model is represented as y=f(x,p), where y is a binary value indicating whether a point is inside or outside an object, x is a three dimensional query coordinate for which a prediction is made, and p is patient specific information, wherein the three dimensional organ shape is generating by iterating over a plurality of x values.

Illustrative embodiment 3. The method according to one of the preceding embodiments, wherein the neural implicit shape function model is represented as y=f(x,p), where y is a signed distance to a nearest boundary of an object, x is a three dimensional query coordinate for which a prediction is made, and p is patient specific information, wherein the three dimensional organ shape is generating by iterating over a plurality of x values.

Illustrative embodiment 4. The method according to one of the preceding embodiments, wherein the two dimensional medical images comprise Intracardiac Echocardiography (ICE) images.

Illustrative embodiment 5. The method according to one of the preceding embodiments, wherein the two dimensional medical images comprise magnetic resonance (MR) images.

Illustrative embodiment 6. The method according to one of the preceding embodiments, wherein generating organ contours comprises segmentation of the plurality of two dimensional medical images using a deep learning method that has been trained with an existing database of Intracardiac Echocardiography images with annotated contours as ground truth.

Illustrative embodiment 7. The method according to one of the preceding embodiments, wherein the annotated contours are converted into contour heat maps, wherein a deep learning based image to image network is trained to predict the heat maps, wherein feature maps from the image to image network are concatenated with point coordinates and used as an input to the neural implicit shape function model.

Illustrative embodiment 8. The method according to one of the preceding embodiments, further comprising aligning the two dimensional medical images in a three dimensional space using image header information.

Illustrative embodiment 9. The method according to one of the preceding embodiments, wherein the trained neural implicit shape function model iterates over every point in a region of interest and predicts a signed distance of each point to a closest boundary.

Illustrative embodiment 10. The method according to one of the preceding embodiments, wherein the trained neural implicit shape function model classifies each point in a region of interest as lying inside or outside the three dimensional organ shape.

Illustrative embodiment 11. The method according to one of the preceding embodiments, wherein the organ contours comprise three dimensional coordinates in space or voxelized in a three dimensional volume.

Illustrative embodiment 12. A system for three dimensional reconstruction from two dimensional imaging data, the system comprising: a medical imaging device configured to acquire a plurality of two dimensional images of a feature of a patient; a memory configured to store a boundary detection machine learned model and an neural implicit shape function model; a processor configured to generate feature contours in each of the plurality of two dimensional images using the boundary detection machine learned model and generate a three dimensional feature shape from the feature contours using the neural implicit shape function model; and a display configured to display the three dimensional feature shape.

Illustrative embodiment 13. The system according to one of the preceding embodiments, wherein the neural implicit shape function model is represented as y=f(x,p), where y is a binary value indicating whether a point is inside or outside an object, x is a three dimensional query coordinate for which a prediction is made, and p is patient specific information, wherein the three dimensional feature shape is generated by iterating over a plurality of x values.

Illustrative embodiment 14. The system according to one of the preceding embodiments, wherein the neural implicit shape function model is represented as y=f(x,p), where y is a signed distance to a nearest boundary of an object, x is a three dimensional query coordinate for which a prediction is made, and p is patient specific information, wherein the three dimensional feature shape is generated by iterating over a plurality of x values.

Illustrative embodiment 15. The system according to one of the preceding embodiments, wherein the medical imaging device comprises an ultrasound system.

Illustrative embodiment 16. The system according to one of the preceding embodiments, wherein the boundary detection machine learned model is configured to segment the plurality of two dimensional images using a deep learning method that has been trained with an existing database of ultrasound images with annotated contours as ground truth.

Illustrative embodiment 17. The system according to one of the preceding embodiments, wherein the neural implicit shape function model iterates over every point in a region of interest and predicts a signed distance of each point to a closest boundary of the feature.

Illustrative embodiment 18. The system according to one of the preceding embodiments, wherein the neural implicit shape function model classifies each point in a region of interest as lying inside or outside a shape of the feature.

Illustrative embodiment 19. A non-transitory computer implemented storage medium that stores machine-readable instructions executable by at least one processor, the machine-readable instructions comprising: acquiring sparse three dimensional data of a volume; training an neural implicit shape function model using the sparse three dimensional data to predict a signed distance of a respective location in the volume to a closest boundary of an feature; and generating a three dimensional feature shape by iterating over a plurality of locations in the volume.

Illustrative embodiment 20. The non-transitory computer implemented storage medium according to one of the preceding embodiments, further comprising: displaying the three dimensional feature shape.

1. A method for three dimensional organ reconstruction from two dimensional sparse imaging data, the method comprising:
acquiring a plurality of two dimensional medical images of a patient;
generating organ contours in the plurality of two dimensional medical images;
training a neural implicit shape function model with the organ contours to regress a three dimensional organ shape; and
generating the three dimensional organ shape using the trained neural implicit shape function model.

2. The method of claim 1, wherein the neural implicit shape function model is represented as y=f(x,p), where y is a binary value indicating whether a point is inside or outside an object, x is a three dimensional query coordinate for which a prediction is made, and p is patient specific information, wherein the three dimensional organ shape is generating by iterating over a plurality of x values.

3. The method of claim 1, wherein the neural implicit shape function model is represented as y=f(x,p), where y is a signed distance to a nearest boundary of an object, x is a three dimensional query coordinate for which a prediction is made, and p is patient specific information, wherein the three dimensional organ shape is generating by iterating over a plurality of x values.

4. The method of claim 1, wherein the two dimensional medical images comprise Intracardiac Echocardiography (ICE) images.

5. The method of claim 1, wherein the two dimensional medical images comprise magnetic resonance (MR) images.

6. The method of claim 1, wherein generating organ contours comprises segmentation of the plurality of two dimensional medical images using a deep learning method that has been trained with an existing database of Intracardiac Echocardiography images with annotated contours as ground truth.

7. The method of claim 6, wherein the annotated contours are converted into contour heat maps, wherein a deep learning based image to image network is trained to predict the heat maps, wherein feature maps from the image to image network are concatenated with point coordinates and used as an input to the neural implicit shape function model.

8. The method of claim 1, further comprising aligning the two dimensional medical images in a three dimensional space using image header information.

9. The method of claim 1, wherein the trained neural implicit shape function model iterates over every point in a region of interest and predicts a signed distance of each point to a closest boundary.

10. The method of claim 1, wherein the trained neural implicit shape function model classifies each point in a region of interest as lying inside or outside the three dimensional organ shape.

11. The method of claim 1, wherein the organ contours comprise three dimensional coordinates in space or voxelized in a three dimensional volume.

12. A system for three dimensional reconstruction from two dimensional imaging data, the system comprising:
a medical imaging device configured to acquire a plurality of two dimensional images of a feature of a patient;
a memory configured to store a boundary detection machine learned model and an neural implicit shape function model;
a processor configured to generate feature contours in each of the plurality of two dimensional images using the boundary detection machine learned model and generate a three dimensional feature shape from the feature contours using the neural implicit shape function model; and
a display configured to display the three dimensional feature shape.

13. The system of claim 12, wherein the neural implicit shape function model is represented as y=f(x,p), where y is a binary value indicating whether a point is inside or outside an object, x is a three dimensional query coordinate for which a prediction is made, and p is patient specific information, wherein the three dimensional feature shape is generated by iterating over a plurality of x values.

14. The system of claim 12, wherein the neural implicit shape function model is represented as y=f(x,p), where y is a signed distance to a nearest boundary of an object, x is a three dimensional query coordinate for which a prediction is made, and p is patient specific information, wherein the three dimensional feature shape is generated by iterating over a plurality of x values.

15. The system of claim 12, wherein the medical imaging device comprises an ultrasound system.

16. The system of claim 15, wherein the boundary detection machine learned model is configured to segment the plurality of two dimensional images using a deep learning method that has been trained with an existing database of ultrasound images with annotated contours as ground truth.

17. The system of claim 12, wherein the neural implicit shape function model iterates over every point in a region of interest and predicts a signed distance of each point to a closest boundary of the feature.

18. The system of claim 12, wherein the neural implicit shape function model classifies each point in a region of interest as lying inside or outside a shape of the feature.

19. A non-transitory computer implemented storage medium that stores machine-readable instructions executable by at least one processor, the machine-readable instructions comprising:
acquiring sparse three dimensional data of a volume;
training an neural implicit shape function model using the sparse three dimensional data to predict a signed distance of a respective location in the volume to a closest boundary of an feature; and
generating a three dimensional feature shape by iterating over a plurality of locations in the volume.

20. The non-transitory computer implemented storage medium of claim 19, further comprising:
displaying the three dimensional feature shape.
